(19) United States
(12) Patent Application Publication
(10) Pub. No.: US 2009/0178974 A1
(43) Pub. Date: Jul. 16, 2009

(54) CONCRETE PUMP WASHOUT SYSTEMS AND METHODS

(75) Inventors: Ernest Kim Leonardich, Santa Cruz, CA (US); Norman P. Gruczelak, Ben Lomond, CA (US)

Correspondence Address: KNOBBE MARTENS OLSON & BEAR LLP, 2040 MAIN STREET, FOURTEENTH FLOOR, IRVINE, CA, 92614, US

(73) Assignee: Onsite Washout Corp., Ben Lomond, CA (US)

(21) Appl. No.: 12/402,233

(22) Filed: Mar. 11, 2009

Related U.S. Application Data
(62) Division of application No. 11/743,012, filed on May 1, 2007.
(60) Provisional application No. 60/798,211, filed on May 6, 2006.

(51) Int. Cl. C02F 1/44; B08B 5/04; C02F 103/12

(52) U.S. Cl. 210/651; 210/416.1; 134/21

(57) ABSTRACT

A concrete strainer used to separate water from wet concrete can include a volume enclosed by a screen or holes in perforated material, connected to a vacuum hose. An extender pipe can be inside the volume and also connect to the vacuum hose. The screen or holes prevent aggregates in the concrete from entering the vacuum hose and clogging an attached vacuum pump. Advantageously, when the strainer is partially submerged into the wet concrete a portion of the strainer exposed to air allows water to flow by gravity into a bottom of the strainer. The extender pipe, being submersed in said water, prevents a vacuum from being lost due to exposure to air pressure.

### CROSS-REFERENCE TO RELATED APPLICATIONS

This application is a divisional of U.S. patent application Ser. No. 11/743,012, filed May 1, 2007, which claims the benefit of U.S. Provisional Application No. 60/798,211 filed May 6, 2006. This application claims priority to both of the above referenced applications, the entirety of each being expressly incorporated herein by reference.

### FIELD OF THE INVENTION

The present invention relates to improvements in washout of concrete apparatus and collection of the washout liquids for transportation to an environmental disposal site and collection of waste solids as blocks of a manageable size for disposal.

### BACKGROUND

Concrete pumps are used to move concrete from concrete trucks to the places on a construction site where it is needed and where the concrete trucks cannot go. There are many types of pumps, including boom pumps, city pumps, line pumps and grout pumps. These concrete pumps typically have an inlet hopper where the concrete trucks deliver metered amounts of liquid concrete by means of a chute. The pump takes the concrete from the hopper and forces it through a series of pipes, hoses, or both, to the place on the construction site where it is used. These pumps and the chute of the concrete truck must be washed clean of waste concrete before the fluid concrete begins to harden. Environmental laws and restrictions on the disposal of this washout water and waste concrete are very strict.

Large construction sites will usually have a washout facility for use by the concrete trucks and pumps. A disposal pit is dug into the ground and is lined with plastic sheet to prevent seepage into the earth. The waste concrete and washout water is deposited in the pit and as the pit is filled and the concrete hardens, the large heavy slab is hauled off to a remote disposal site. One problem with this approach is the potential for an environmentally prohibited seepage into the ground. A newer method is to use a large transportable metal container instead of digging a pit. In either case, the concrete pump and concrete truck must be moved to the pit and sometimes a wait is involved before the pit is available, before the pump or truck chute can be washed out. Moreover, many concrete pumping jobs involve improvements to existing structures, and are located in cities or towns, where there is no room for a washout facility. To make matters worse, concrete trucks and pumps must operate on paved roads, or in landscaped areas where no contamination by waste concrete will be tolerated.

### SUMMARY

The systems and methods disclosed herein provide environmentally sustainable modes of operating concrete pumps so that the onsite spillage of washout water and waste concrete is substantially eliminated. In one embodiment, the waste water and waste concrete from the pump clean-out are caught in a tub. The liquids are then removed from the tub with a suction water-solid separator. This water-solid separator removes a substantial amount of liquid from the tub to a storage tank for re-use or removal to an environmentally approved discharge site. The remaining water and waste concrete hardens into easily disposed of blocks of concrete of manageable size which are easily hauled away or used on-site as fill material or other purposes.

Another mode of use provides for thorough washout of the chute of the concrete truck without any spillage of concrete or washout water. In this mode, washout water and waste concrete from the chute are dumped into the concrete pump hopper. The suction water-solid separator evacuates the used washout water from the hopper back into the cement truck for later disposal or re-use.

In one embodiment, the system is implemented by a suction water-solids separator connected by vacuum base to a vacuum pump which discharges the evacuated water into a tank disposed on the truck or trailer hauling the cement pump.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

FIG. 1 illustrates a concrete pump installed on a trailer pulled by a truck on which a washout system is installed.

FIG. 2 is a perspective view of another embodiment wherein both the concrete pump and washout system are installed on a truck.

FIG. 3 is a perspective view illustrating use of a concrete pump delivering concrete to a site remote from the concrete truck.

FIG. 4A is a cross-sectional view of the washout tub and water-solid separator unit.

FIG. 4B is another cross-sectional view of the washout tub and water-solid separator.

FIG. 5 is a perspective view of another embodiment of the washout tub.

FIG. 6A is a perspective view of the washout tub and discard concrete partitioning device.

FIG. 6B is a perspective view illustrating use of the discard concrete partitioning device to mold manageable concrete blocks.

FIG. 7 illustrates an embodiment where the washout system is used to wash out the chute of the concrete truck.

FIG. 8 is a detailed right side horizontal view of one embodiment of the washout water holding tank shown in FIGS. 1 and 2.

FIG. 9 is a detailed front horizontal view of the washout water holding tank shown in FIGS. 1 and 2.

FIG. 10 is a detailed left side horizontal view of the washout water holding tank shown in FIGS. 1 and 2.

FIG. 11 is a detailed bottom view of the washout water holding tank shown in FIGS. 1 and 2.

FIG. 12 is a detailed top view of the washout water holding tank shown in FIGS. 1 and 2.

FIG. 13 illustrates one embodiment of the water-solid separator.

FIG. 14 is a cross-sectional view of the water-solid separator taken along lines 14-14 of FIG. 13.

### DETAILED DESCRIPTION OF THE PREFERRED EMBODIMENTS

### Concrete Pump System

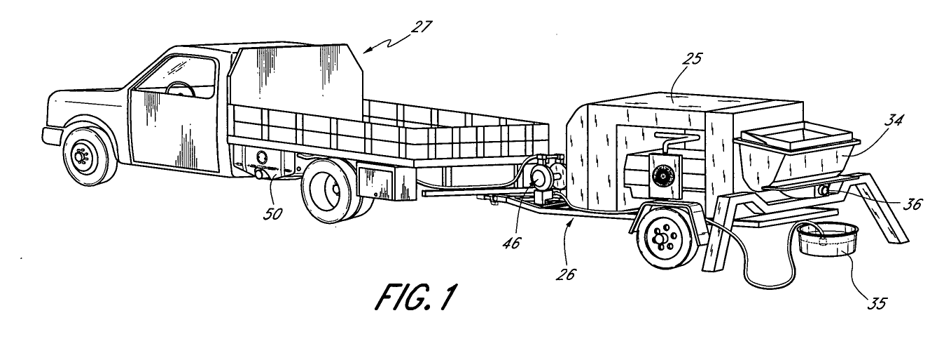

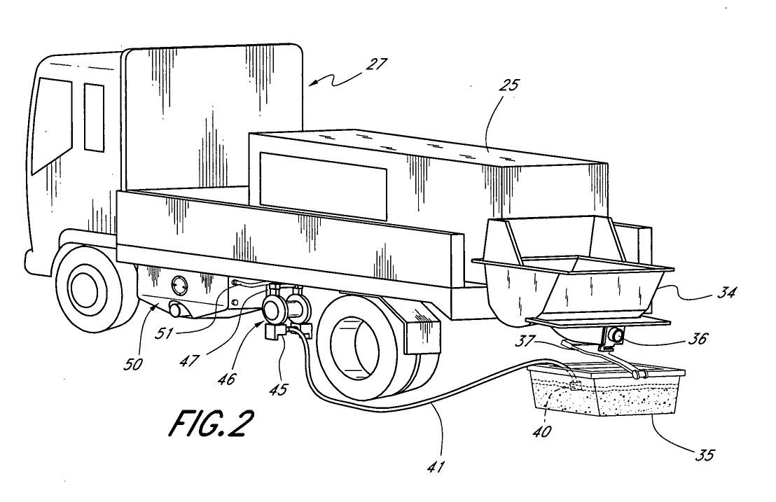

Referring now to FIGS. 1, 2, and 3, a concrete pump 25 is typically mounted on a trailer 26 pulled by a truck 27 (see FIGS. 1, 3) or on a truck 27 (see FIG. 2). By way of specific example, the typical concrete pump 25 uses a ram piston in which a cylinder is filled with concrete during the backstroke of the piston. A forward stroke of the piston pushes the concrete through the concrete pump outlet 36 into a pipeline 30 leading from the concrete pump 25 to the remote job site 31 (see FIG. 3). However, the apparatus and methods described below are not limited to any particular type of concrete pump and have utility for cleaning any type of concrete pump.

A typical concrete pumping situation is shown in FIG. 3. A concrete truck 32 is driven up to the concrete pump 25 mounted on truck 27 or trailer 26 and discharges mixed concrete from chute 33 into hopper 34 mounted on the concrete pump truck 27 or trailer 26. The concrete pump 25 withdraws concrete from hopper 34 and forces the liquid concrete mixture through outlet 36 into the pipeline 30 leading to the job site 31. Pipeline 30 may be rigid pipes, flexible hoses, or a combination thereof.

When the necessary concrete mixture has been pumped or at the end of the work day, the concrete pump 25 must be washed clean of any remaining concrete mixture.

### Concrete Pump Washout

The embodiments described herein perform the concrete pump washout very efficiently and in an environmentally correct manner. Referring to FIG. 2, a tub 35 is positioned below the cleanout outlet 37 of hopper 34. Such a cleanout outlet 37 is standard with concrete pump hoppers and is normally located on the bottom of hopper 34. This outlet is opened as shown in FIG. 2, at the start of the washout procedure so that leftover concrete and washout water flow out of the bottom of hopper 34 through cleanout outlet 37 into tub 35. Typically, the pipeline 30 in FIG. 3 is also disconnected from the outlet 36 of the concrete pump before the washout of concrete pump 25. Washout water is then sprayed into the hopper 34 and the concrete pump outlet 36 while, in one embodiment, the concrete pump 25 is run in reverse to withdraw into hopper 34 the concrete left over in the concrete pump 25. Thus, the waste concrete in pump 25 and the washout water sprayed into outlet 36 are withdrawn from the concrete pump 25 and flow into hopper 34. This waste concrete and wash water then flow through the cleanout outlet 37 of the hopper 34 into tub 35.

Some concrete pumps do not reverse. Typically they include a swing away assembly that provides access to the pump assembly at the rear of the hopper. For this type of pump, the tub 35 is positioned at the rear of the hopper to collect the waste concrete.

Suction water-solid separator unit 40 is placed into tub 35 as shown. The washout water in tub 35 is filtered to remove all but fine particles of concrete by suction water-solid separator unit 40 and the filtered water delivered to storage tank 50. As shown, separator unit 40 is attached to a vacuum suction hose 41 extending from an intake port 45 of a wash water pump 46. The outlet port 47 of this wash water pump 46 is connected by hose 51 to the waste water storage tank 50. As described in detail below, the separator unit 40 can be partially submerged into the waste concrete collected in tub so that when washwater pump 46 is turned on, the filtered waste water collected in tub 35 is withdrawn through hose 41 into the waste water storage tank 50. Unit 40 evacuates a substantial portion of the washout water sprayed into hopper 34 and into concrete pump outlet 36. Not all of the water need be evacuated from the tub 35, rather the amount of water to be removed is the amount necessary to achieve the environment goal of removing substantially all the liquid and solid waste from the job site without spilling liquids or liquid concrete onto the ground. So long as the washout water remaining in the tub 35 is either evaporated or absorbed by the concrete waste to form solid concrete after setting, this goal will be achieved.

After washout of the concrete pump 25 has been completed, the cleanout outlet 37 in hopper 34 is closed and the tub 35, then holding only a small amount of water, can be slid from beneath the hopper 34.

With the wash water pump 46 still running, the separator 40 can be placed into a bucket of water for cleaning with the wash water being evacuated to tank 50. The separator 40 is then removed from the vacuum hose 41. Water from a water hose is then sprayed into the open end of the vacuum suction hose 41 for cleaning both the hose 41 and wash water pump 46 into the waste water holding tank 50. The water pump 46 may now be turned off and the vacuum hose 41 stowed for transport. The concrete pump 25 is now ready for another job without first having to be moved to a disposal site for washout.

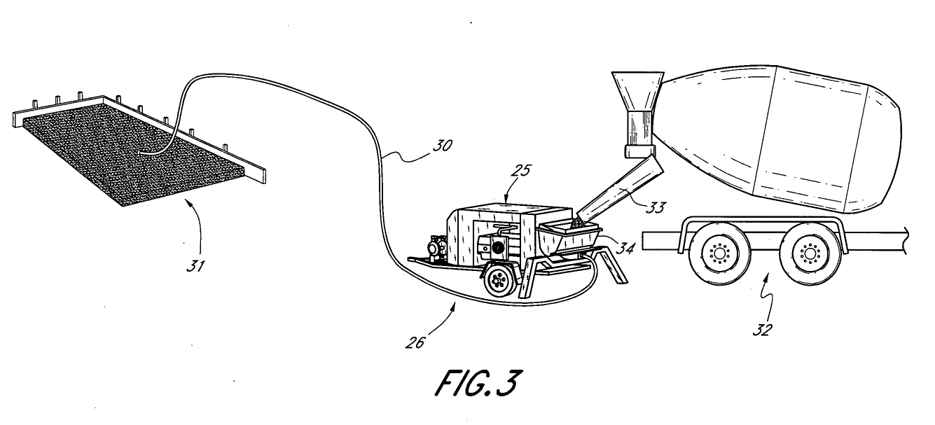

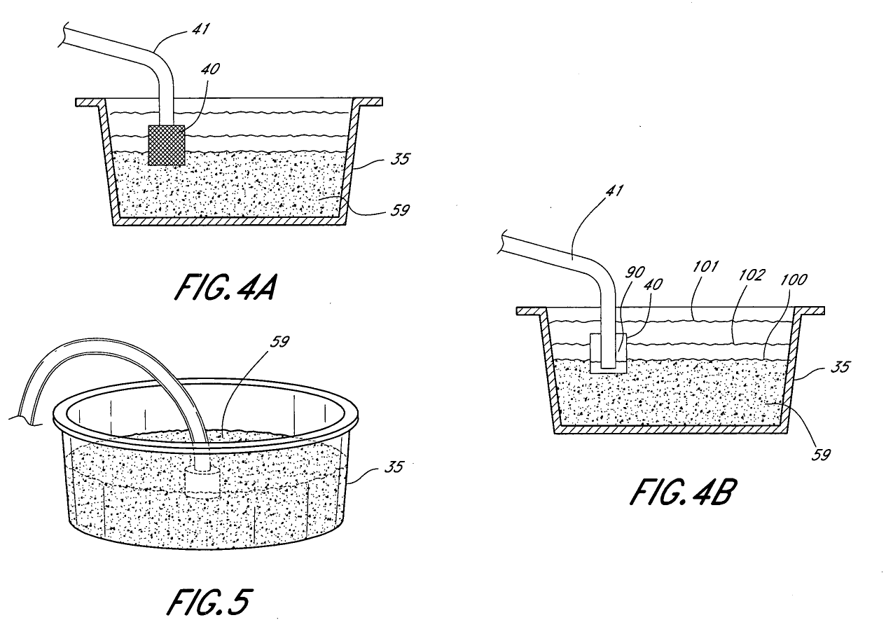

The waste concrete 59 remaining in tub 35 (see FIGS. 4A, 4B and 5) is then allowed to harden and, after hardening, removed from the tub and, in one mode, disposed of with the other solid discards from the building site. Advantageously, before the waste concrete 59 in tub 35 has set, a waste concrete partitioner 60 is utilized to form more manageable smaller and lighter blocks 65 of waste concrete. One embodiment of a waste concrete partitioner 60 is shown in FIGS. 6A and 6B, formed by two center planar members 61 and two parallel orthogonal planar members 62, 63. The partitioner 60 is pushed into the remaining fluid cement 59 in tub 35. After the waste cement in tub 35 has hardened, it can be removed from the waste concrete tub 35 by turning the tub over. When, for example, the hardened waste concrete is struck by a heavy hammer, the partitioner 60 allows the waste concrete to split easily into nine smaller blocks 65 typically 8″ by 8″ and weighing typically no more than 25 lb. each so that each block can be thrown into an on-site waste pick-up for removal with other waste solids for easy handling and disposal.

The blocks 65 may be also used as on-site filler matter or otherwise,

The tub 35 and partitioner 60 are not limited to only forming blocks. The tub and partitioner can be shaped to provide a mold for forming a usable concrete structure such as a support pier or forming decorative objects.

It is also not necessary to use the waste concrete partitioner 60 if the total contents of the tub 35 can be handled as one piece. The partitioner 60 may be constructed from inexpensive fibreboard, plastic or the like and may or may not be re-used. Tub 35 can be formed into any convenient shape and is not limited to the rectangular and cylindrical configurations shown in the drawings. The word “tub” has no particular meaning and is meant to cover any kind of appropriate receptacle for avoiding spillage by catching the waste concrete and wash water removed from hopper 34.

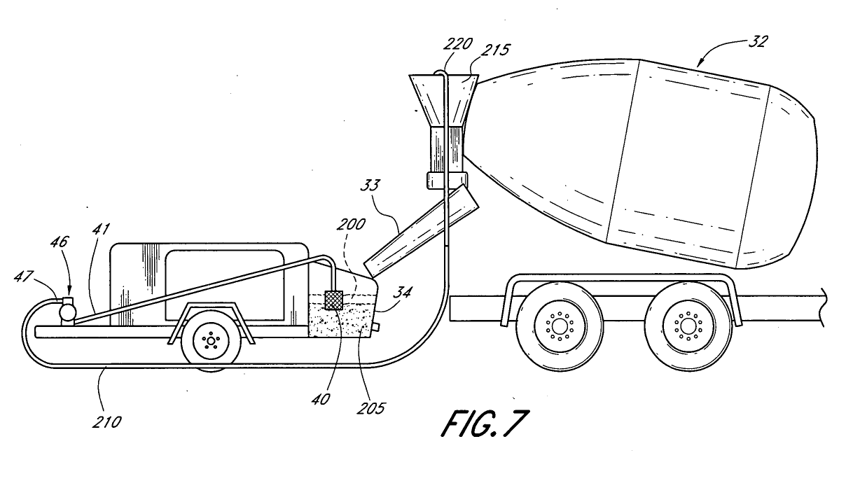

The washout water holding tank 50 is easily emptied when full, whenever or wherever it is convenient and environmentally appropriate. In some situations, the washout water holding tank 50 can be conveniently emptied into the hopper of a concrete truck 30 equipped with a vacuum pump (not shown). The tank liquid outlet fitting 151 (see FIGS. 9 and 10) is connected to this vacuum pump. In this mode, the drain washout water tank is pumped into the input hopper of the concrete truck for re-use at the concrete yard.

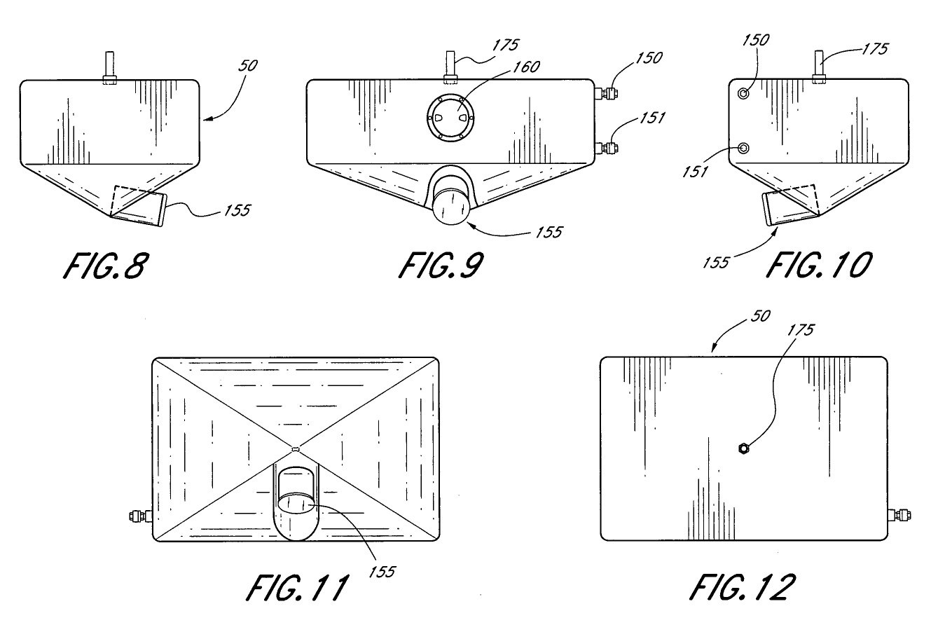

As described in more detail below and shown best in FIGS. 8-12, settled cement and sand sediment buildup in the tank 50 is easily removed by virtue of a downward sloping tank bottom and cleanout port 155.

The system can also serve as a water conservation system. Since the solids in tank 50 settle to the tapered bottom, the water on top is relatively free of particulate matter and can be pumped out and re-used, for example, for priming concrete pump hose 30.

### The Water-Solid Separator Unit

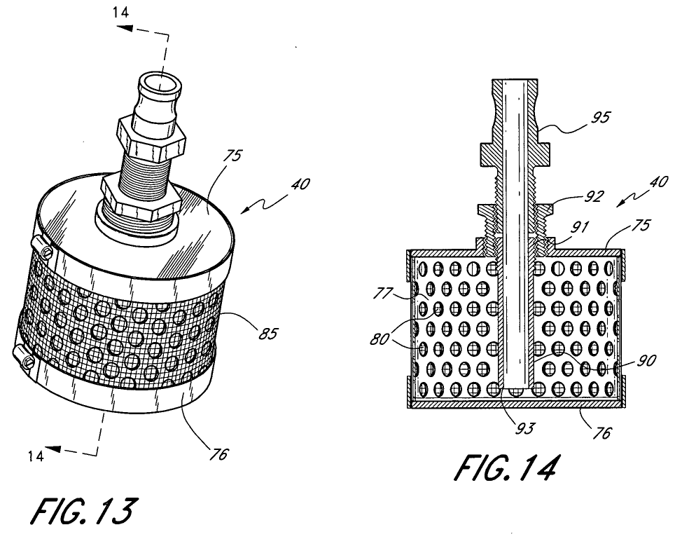

The water-solid separator unit 40 is shown in detail in FIGS. 13 and 14 and includes a cage formed by a top cover 75, bottom cover 76, and a cylindrical inner member 77 having a plurality of through hole openings 80 formed in its wall. A mesh 85 is located around the outside of member 77. Mesh 85 serves as an aggregate strainer and is sized to prevent entry into the interior of separator 40 of solids large enough to clog or damage the hose 41, wash water pump 46 or storage washout water tank 50. By way of specific example, one embodiment of the separator 40 has an outer diameter of 4″, a height of 3.5″ and the mesh 85 is 1/16″, i.e. particles larger than 1/16″ will be prevented from entering vacuum hose 40.

Unit 40 further includes extension pipe 90 having one end 91 attached to threaded coupling 92 attached to the top cover member 75. Extension pipe 90 extends into the interior of the cage formed by members 75, 76, and 77. Vacuum hose coupling 95 is attached to coupling 92 in communication with the extension pipe 90. Coupling 95 is adapted to be connected to vacuum hose 41. The distal end 93 of extension pipe 90 faces the bottom cover member 76 but with sufficient space between the end 91 and the bottom 76 so as to not interfere with the suction provided by vacuum hose 41 when the wash water pump 46 is activated.

The embodiment of unit 40 illustrated is constructed to maintain evacuation of the waste water for tub 35 so long as some portion of the aggregate strainer mesh 85 remains above the waste concrete level 100. Thus, as shown in FIGS. 4A, 4B and 5, the external part of the strainer 85 which is immersed into the waste concrete 100 will tend to block some inflow of water into the interior of the unit cage, namely that portion of the strainer mesh 85 submerged into the concrete solids 100. However, water will continue to be evacuated even though the unit is totally submerged below the water level (see level 101 in FIG. 4B). This evacuation flow of water is provided by the extension pipe 90 attached to hose 41. As shown in FIGS. 4A and 4B, the extension pipe 90, attached to the hose 41 allows the strainer to be partially submersed in concrete 100, but with a significant surface exposed to air, since the water will flow into the strainer by gravity and the extension pipe distal end 91 being submersed in the water contained in unit 40, will not be exposed to air thereby preserving vacuum within extension pipe 90 and hose 41 and enable unit 40 to continue sucking out the wash water within the cage of unit 40. This is so even when the water level drops to level 102 (see FIG. 4B).

### The Washout Water Holding Tank

One embodiment of the washout water holding tank 50 is shown in the detailed drawings of FIGS. 8-12. The tank 50 includes inlet fitting 150 for attachment to hose 51 from wash water pump 46. Tank 50 further includes water outlet fitting 151. By way of specific example, one embodiment of tank 50 holds 50 gallons of liquid.

The entire bottom of tank 50 is sloped advantageously to a large drain 155 (see FIGS. 8-11) so that when drain 155 is opened, any solids small enough to pass through the mesh strainer 85 (FIG. 14) will settle to the tank bottom and are easily cleaned out through drain. Cleanout of tank 40 is further facilitated by water tight cleanout port 160 which allows a water hose to be physically inserted into the tank 50 to flush out any sediment remaining after the drain 155 is opened.

Vent 175 vents the tank 50 to outside air and maintains the air pressure within tank 50 at atmospheric pressure. Accordingly, the walls of tank 50 will not be subject to any excess air pressure when the tank is filling with washout water or is being drained of waste water. Therefore, the walls of tank 50 can be made inexpensively from plastic, metal, or other water tight material and do not need to be strong enough to support either a vacuum or air pressure.

### The Washwater Pump

Many different types of pumps may be used for the washwater pump 46. One specific example of a useful pump is the Yamada Model ND P-25-BAN air powered double diaphragm pump.

### Packaging the System Components

In FIG. 1, the washwater holding tank 50 is attached below the bed of truck 27 and washwater pump 46 is located on trailer 26. In FIG. 2, the washwater holding tank 50 and washwater pump 46 are both located on truck 27. These locations are, by no means, the only locations for these components and the use of the system has substantial flexibility in locating these components. Thus, in other embodiments, the washwater pump 46 and holding tanks can be mounted together as a pre-packaged system for installation on a truck or trailer or separately mounted as suits the convenience of the user and the space availability for the components.

### Concrete Truck Chute Washout

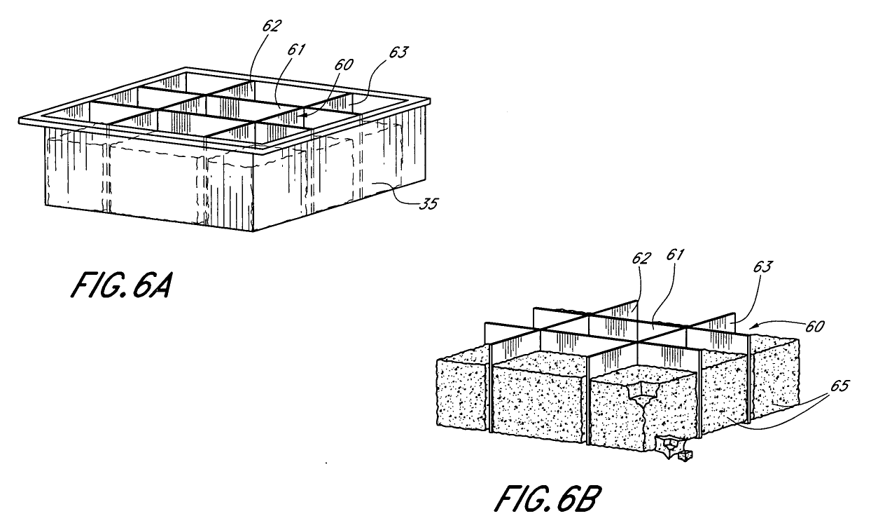

A further advantageous mode of use of the concrete pump washout system is shown in FIG. 7.

In normal operation, the concrete truck 32 is positioned such that its chute 33 will pour liquid concrete into the concrete pump hopper 34. It is not unusual for a number of truck loads of concrete to be used on one job, so if the truck chute 33 is washed out into the pump hopper 34 after each load, the waste water 200 must be removed from the pump hopper or the next load of concrete delivered to the pump will be diluted.

The water-solid separator unit 40 is mounted to the end of vacuum hose 41 connected to the vacuum end 45 of wash water pump 46. The separator unit 40 is placed into hopper 35 and typically pushed partially into the concrete 205 in the concrete pump hopper 34. The pressure end 47 of the water pump 46 is connected to output hose 210 and directed into the concrete truck hopper 215. A pipe 220 with a hook on the exit end can be connected to output hose 210 and used to hang over the truck hopper 215 for easy access from the ground. The waste water 200 is then pumped from the pump hopper 34 into the truck hopper 215. Once the water is substantially removed, the truck 32 can go back to the yard for the next job and the pump is ready for its next load. The concrete washed out of the chute 33 into hopper 34 will mix with any concrete left from the previous job and either be mixed with the next load of concrete poured into hopper 34 or be washed out of the hopper 34 at the end of the pumping operation in the manner described above.

### CONCLUSION

The above presents a description of the best mode contemplated for the concrete pump washout systems and methods in such full, clear, and exact terms as to enable any person skilled in the art to which it pertains to produce these systems and practice these methods. These apparatus and methods are, however, susceptible to modifications that are fully equivalent to the embodiment discussed above. Consequently, these apparatus and methods are not limited to the particular embodiments disclosed. On the contrary, these apparatus and methods cover all modifications coming within the spirit and scope of the present invention.

What is claimed is:

1. A concrete strainer used to separate water from wet concrete comprising:
a volume enclosed by a screen or holes in perforated material connected to a vacuum hose; and
an extender pipe inside the volume connected to the vacuum hose;
whereby the screen or holes prevent aggregates in the concrete from entering the vacuum hose and clogging an attached vacuum pump, and
whereby when the strainer is partially submerged into the wet concrete a portion exposed to air allows water to flow by gravity into a bottom of the strainer, the extender pipe being submersed in said water preventing a vacuum from being lost due to exposure to air pressure.

2. The strainer of claim 1, wherein the volume is enclosed by a screen.

3. The strainer of claim 1, wherein the volume is enclosed by holes in perforated material.

4. The strainer of claim 1, wherein the screen or holes strain out particles larger than 1/16 inch.

5. The strainer of claim 1, wherein the volume is generally cylindrical.

6. An environmentally sustainable method of washing the chute of a concrete truck, comprising:
washing out said chute so that the waste concrete and washout water are caught in the hopper of a concrete pump; and
inserting a suction water-solid separator into said hopper to remove water from said hopper and into the hopper of the cement truck.

7. The method of claim 6, wherein the separator is inserted at least partially into a layer of concrete solids, after a layer of water has separated.

8. The method of claim 6, comprising the additional step of removing sufficient water such that all remaining water is either evaporated or absorbed by the waste concrete to form solid concrete.

9. The method of claim 6, wherein the separator is inserted such that a significant surface of the separator is exposed to air.

10. The method of claim 9, wherein the surface of the separator exposed to air is in communication with a suction portion of the separator.

11. A concrete strainer comprising:
a means for coupling to a vacuum hose;
a cage coupled to the means for coupling and forming an enclosed volume, the cage further comprising a mesh screen and a plurality of through holes in communication with the mesh screen; and
a pipe extending into the cage and in communication with the vacuum hose.

12. The strainer of claim 11, wherein the strainer strains out particles larger than 1/16 inch.

13. The strainer of claim 12, wherein the mesh screen has a mesh size of 1/16 inch.

14. The strainer of claim 11, wherein the mesh screen is external from the through holes.

15. The strainer of claim 11, wherein the cage is generally cylindrical.

16. The strainer of claim 11, wherein the cage has a height of approximately three and a half inches.

17. The strainer of claim 11, wherein the means for coupling comprises a threaded coupling.

18. A wet concrete and surface water separator unit comprising:
an upper end comprising a suction pump connector;
a lower end having a bottom surface, a top surface, and a lip extending upwardly from the top surface of the lower end to form a generally fluid impervious cup such that the bottom surface of the lower end of the separator unit may be placed at or near the interface between wet concrete and a water layer located above the wet concrete while limiting entry of the wet concrete into the separator;
a mesh extending upwardly from the lip at or near the lower end to the upper end of the separator unit to form a space within the separator unit, the mesh being sized such that it generally blocks the entry of concrete aggregate of a size which may cause significant damage to a suction pump; and
a suction conduit extending from the suction pump connector to a location in said space within the separator unit and closely adjacent to the upper surface of the lower end whereby most of the upper water may be suctioned out leaving substantially only the wet concrete.

19. The separator unit of claim 18, further comprising a plurality of through holes on a surface extending between the upper and lower ends.

20. The separator unit of claim 18, wherein mesh separates out particles larger than 1/16 inch.

21. A method of separating water from wet concrete comprising:
maintaining a water-solid separator in a mix comprising a water layer and a wet concrete layer, the separator comprising a straining surface that is permeable to water but generally impermeable to concrete aggregates;
suctioning water through the separator into a holding vessel; and
continuing the suctioning of water while a significant portion of the straining surface is exposed to the water layer and another significant portion of the straining surface is exposed to the wet concrete layer.

22. The method of claim 21, wherein at some point the suctioning of water continues while a significant portion of the straining surface is also exposed to an ambient atmosphere.

23. The method of claim 21, further comprising the step of washing away concrete with water to create a mix comprising water and wet concrete in a washout container.

24. The method of claim 23, further comprising the step of allowing the remaining wet concrete to set in the washout container after a suctioning of water has completed.

25. The method of claim 24, further comprising the step of dislodging the set concrete to automatically form multiple concrete blocks of a predetermined shape.

26. The method of claim 21, wherein the holding vessel is a vented tank.
